(19) United States
(12) Patent Application Publication
(10) Pub. No.: US 2021/0370427 A1
(43) Pub. Date: Dec. 2, 2021

(54) BRAZED JOINT BODY, BRAZING METHOD, AND BRAZING MATERIAL

(71) Applicant: Mitsubishi Electric Corporation, Chiyoda ku, Tokyo (JP)

(72) Inventors: Koji ASAMA, Tokyo (JP); Hiroaki TATSUMI, Tokyo (JP); Hiroshi YAMAGUCHI, Tokyo (JP)

(73) Assignee: Mitsubishi Electric Corporation, Chiyoda-ku, Tokyo (JP)

(21) Appl. No.: 16/642,073

(22) PCT Filed: Nov. 12, 2018
(86) PCT No.: PCT/JP2018/041841

§ 371 Date: Feb. 26, 2020

(30) Foreign Application Priority Data
Nov. 17, 2017 (JP) 2017-221838

(51) Int. Cl. B23K 1/00; B23K 1/008; B23K 1/19; B23K 35/28; B23K 35/30

(52) U.S. Cl. CPC B23K 1/0008; B23K 1/008; B23K 1/203; B23K 35/286; B23K 35/3053; B23K 1/19

(57) ABSTRACT

A brazing material is interposed between an aluminum-based material and an iron-based material plated with Ni. The brazing material has a structure in which an Al—Si—Ni based alloy layer and an Al layer are bonded via a flux layer. A structure for brazing is formed such that the Al—Si—Ni based alloy layer is located on the aluminum-based material side and the Al layer is located on the iron-based material side. The structure is heated in a furnace and is thereafter cooled, thereby obtaining a brazed joint body in which the Ni plating that is a barrier layer remains and an Al—Ni layer is formed.

### TECHNICAL FIELD

The present disclosure relates to a brazed joint body, a brazing method, and a brazing material.

### BACKGROUND ART

When an aluminum-based material having aluminum as a primary component and an iron-based material having iron as a primary component are brazed, a method for brazing those materials with an Al—Si based alloy as a brazing material is generally used.

However, this method may cause Fe in the iron-based material to diffuse into the brazing material when the brazing material is melted. Thus a brittle Al—Fe—Si based alloy with low ductility is likely to be formed at an interface between the aluminum-based material and the iron-based material. Such formation of the Al—Fe—Si based alloy disadvantageously decreases brazing strength.

To address this issue, Patent Literature 1 proposes suppression of formation of the brittle Al—Fe—Si based alloy by covering the surface of the iron-based material with Ni plating so that the resulting Ni plating layer functions as a diffusion barrier layer.

### CITATION LIST

### Patent Literature

Patent Literature 1: Unexamined Japanese Patent Application Kokai Publication No. 2002-336959

### SUMMARY OF INVENTION

### Technical Problem

Even with a brazing technique of Patent Literature 1, however, Ni plating may dissolve in the brazing material if heating due to furnace brazing is prolonged, thereby losing the function as the diffusion barrier layer. As a result, a brittle Al—Fe—Si based alloy is formed at the interface between the aluminum-based material and the iron-based material, which decreases brazing strength.

In view of the above circumstances, an objective of the present disclosure is to provide a brazed joint body with high joint strength after the furnace brazing. Another objective is to provide a brazing method for the brazed joint body and a brazing material.

### Solution to Problem

To achieve the above objectives, a brazed joint body according to an aspect of the present disclosure is a brazed joint body of an aluminum-based material and an iron-based material plated with Ni. The brazed joint body includes a layered structure including, sequentially from an iron-based material side, the iron-based material, a Ni plating layer, an Al—Ni based alloy layer, an Al—Si based alloy layer, and the aluminum-based material. A nearly spherical Al—Ni based alloy is formed in the Al—Si based alloy layer.

### Advantageous Effects of Invention

The present disclosure prevents elimination of the Ni plating layer that is a barrier layer of the iron-based material in furnace brazing, and the Al—Ni based alloy is formed instead of a brittle Al—Fe—Si based alloy layer. The nearly spherical Al—Ni based alloy is formed. Thus the brazed joint body having a high joint strength after the furnace brazing, a brazing method, and a brazing material are obtained.

### BRIEF DESCRIPTION OF DRAWINGS

FIG. 1 is a perspective view of a brazed joint body according to Embodiment 1 of the present disclosure;

FIG. 2 is a cross-sectional scanning electron microscope (SEM) image of the brazed joint body according to Embodiment 1;

FIG. 3 is a material placement drawing for brazing of the aluminum-based material and the iron-based material according to Embodiment 1;

FIG. 4 is a cross-sectional view of a brazing material according to Embodiment 1;

FIG. 5 is a cross-sectional view of a wire type brazing material according to Embodiment 5 of the present disclosure;

FIG. 6 is a material placement drawing for brazing of the aluminum-based material and the iron-based material according to Embodiment 5;

FIG. 7 is a cross-sectional SEM image, representing a material placement drawing, of a brazed joint body of a comparative example that is compared with an example of the present disclosure;

FIG. 8 is a cross-sectional view of a brazing material according to Embodiment 7;

FIG. 9 is a cross-sectional view of a brazing material according to Embodiment 8; and

FIG. 10 is a cross-sectional view of a brazing material according to Embodiment 9.

### DESCRIPTION OF EMBODIMENTS

A brazed joint body, a brazing method, and a brazing material according to embodiments of the present disclosure are described hereinafter with reference to the drawings. The present disclosure is not limited to the embodiments described below.

### Embodiment 1

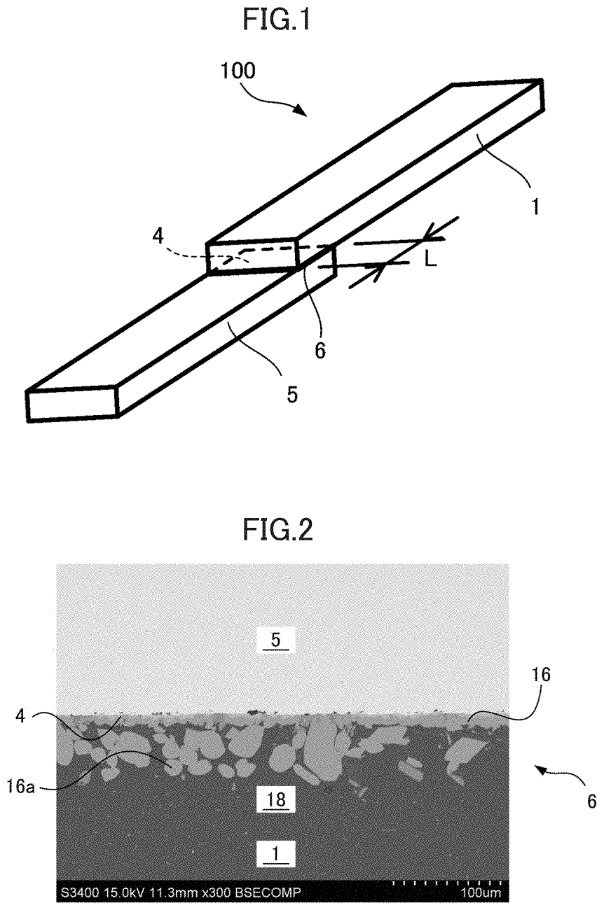

FIG. 1 is a perspective view of a brazed joint body 100 according to Embodiment 1.

As illustrated in FIG. 1, a brazed joint body 100 is formed by brazing together an aluminum-based material 1 and an iron-based material 5. The aluminum-based material 1 and the iron-based material 5 each have a flat-bar shape. The aluminum-based material 1 and the iron-based material 5 overlap each other by a length L at one end of each material and are brazed at a portion of a brazing portion 6. A Ni plating layer 4 is formed on a surface of the iron-based material 5. The brazing portion 6 is formed between the aluminum-based material 1 and the Ni plating layer 4. The aluminum-based material 1 in the present embodiment may include pure aluminum.

FIG. 2 is a cross-sectional SEM image of the vicinity of the brazing portion 6 of the brazed joint body 100 according to Embodiment 1.

As illustrated in FIG. 2, the brazing portion 6 of the brazed joint body 100 in Embodiment 1 has a layered structure including, sequentially from the iron-based material 5 side, the iron-based material 5, the Ni plating layer 4, an Al—Ni based alloy layer 16, an Al—Si based alloy layer 18, and the aluminum-based material 1.

The Al—Si based alloy layer 18 corresponds to a layer predominantly of a base material of Al—Si formed from an Al—Si base material 14 of the brazing material 3 described below in FIG. 4.

A nearly spherical Al—Ni based alloy layer 16a is formed at a portion located near the Al—Ni based alloy layer 16 within a region of the Al—Si based alloy layer 18. The shape of an interface between the Al—Ni based alloy layer 16 and the Al—Si based alloy layer 18 is smoothly continuous. Specifically, the shape is undulating with upward convexities and downward convexities repeating at a substantially constant cycle.

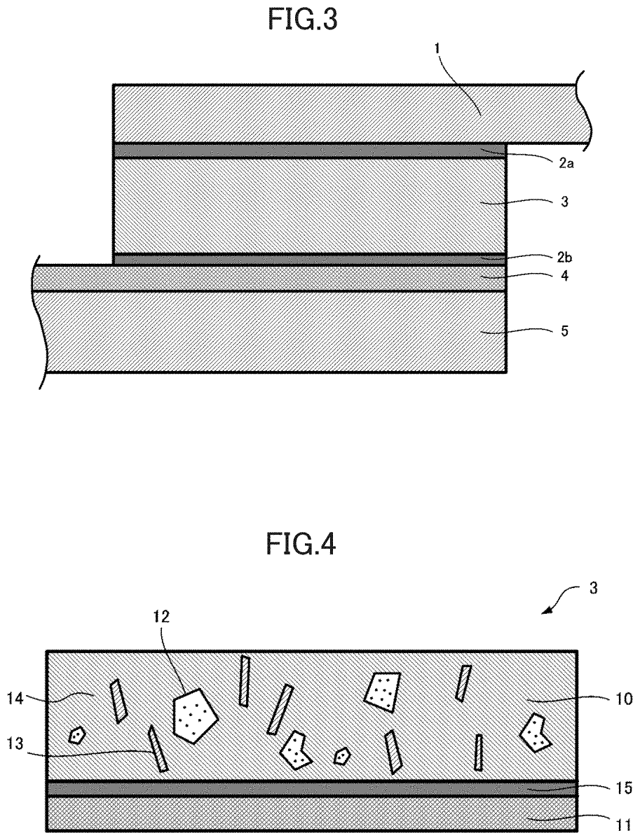

Next, a method for producing the brazed joint body 100 is described. FIG. 3 is a cross-sectional view illustrating a method for arranging materials during brazing according to Embodiment 1.

First, targets to be brazed, that is, the aluminum-based material 1 and the iron-based material 5 are prepared. One surface of the iron-based material 5 is covered with the Ni plating layer 4 having a thickness of 1 to 10 μm.

Examples of methods for covering the Ni plating layer 4 include electrolytic plating and electroless plating. However, the method for covering the Ni plating layer 4 is not limited thereto. The thickness of the Ni plating layer 4 is preferably 3 μm or more in terms of its function as the diffusion barrier layer.

Then a structure for furnace brazing is formed. In an example of FIG. 3, the structure is formed as a stack including the aluminum-based material 1 and the iron-based material 5. Temporary fixing of the stack together is not illustrated but is performed by a known method.

The brazing material 3 is placed via a flux layer 2b on the Ni plating layer 4 formed on the iron-based material 5. In FIG. 3, the Ni plating layer 4 is omitted from any surface other than the surface where brazing is performed. The aluminum-based material 1 is placed via the flux layer 2a on the brazing material 3.

The flux layers 2a and 2b are formed by mixing Nocolok (registered trade mark) flux powder with a volatile organic solvent, for example ethanol, to form a paste and then applying the mixture to each material. However, the method for providing the flux layers 2a and 2b is not particularly limited.

The stack of materials placed as in FIG. 3 is heated in a furnace under an inert atmosphere, for example under a nitrogen atmosphere. The heating temperature is within a range of temperature that is not below a melting start temperature, at which the brazing material 3 starts melting, and not above 640° C. The reason for setting the upper limit to 640° C. is for preventing, when the material of the aluminum-based material 1 is pure Al, a base material of the aluminum-based material 1 from melting due to the melting point of the pure Al that is approximately 660° C. The structure is held at a temperature within the range for a certain period of time and then is cooled to room temperature. The maximum temperature attained at heating is, for example, near 600° C., which is a middle of a range of the melting start temperature of the brazing material 3 to 640° C. The heating may end when the maximum temperature attained is reached, and cooling within the furnace may start.

Through the brazing described above, the brazed joint body 100 with the aforementioned brazing portion 6 can be formed.

Next, the brazing material 3 for use in brazing is described in detail. FIG. 4 is a cross-sectional view of the brazing material 3.

The brazing material 3 is a stack of an Al layer 11, a flux layer 15, and an Al—Si—Ni based alloy layer 10 sequentially from the lower side of FIG. 4, corresponding to a stacking direction in FIG. 3. The Al—Si—Ni based alloy layer 10 is located on the aluminum-based material 1 side, and the Al layer 11 is located on the iron-based material 5 side.

The Al—Si—Ni based alloy layer 10 is formed of an Al—Si—Ni based alloy that is used as the brazing material. As illustrated in FIG. 4, when the cross section of the layer of the Al—Si—Ni based alloy layer 10 is viewed, an Al—Ni alloy phase 12 and an Al—Si alloy phase 13 are distributed in a floating island-like pattern in the Al—Si base material 14.

The composition of the Al—Si base material 14 is 3 atomic % or less Si, the balance being Al. The balance here in the description of the present embodiments includes inevitable impurities.

The composition of the Al—Si alloy phase 13 is 3 atomic % or less Si, the balance being Al.

The composition of the Al—Ni alloy phase 12 is 0.01 to 50 atomic % Ni, the balance being Al.

The proportion of Ni of the Al—Ni alloy phase 12 depends on the mass proportion of the Ni of the overall mass of the Al—Si—Ni based alloy layer 10. For example, when the proportion of Ni included in the Al—Si—Ni based alloy layer 10 is 8 mass %, the proportion of Ni of the Al—Ni alloy phase 12 is a value near 25 atomic %.

A volume proportion of the Al—Si alloy phase 13 and the Al—Ni alloy phase 12 occupying in the overall volume of the Al—Si—Ni based alloy layer 10 varies depending on a mass proportion of Si and a mass proportion of Ni included in the Al—Si—Ni based alloy layer 10. An example may be considered in which the proportions of Si and Ni included in the Al—Si—Ni based alloy layer 10 are 7 mass % and 8 mass %, respectively. In this case, the volume proportion of the Al—Si alloy phase 13 occupying in the Al—Si—Ni based alloy layer 10 takes a value near 7%. The volume proportion of the Al—Ni alloy phase 12 takes a value near 20%. The Al—Si alloy phases 13 and the Al—Ni alloy phases 12 are preferably distributed uniformly in the Al—Si base material 14.

The Al—Si—Ni based alloy layer 10 can be produced by fabricating an alloy including 5 to 12 mass % of Si and 0.01 to 30 mass % of Ni, and then rolling the alloy into a plate-like workpiece form having a thickness of 0.05 to 0.2 mm.

When Si content is less than 5 mass %, the melting point of the Al—Si—Ni based alloy layer 10 increases. Thus brazing without melting the base material is difficult to achieve. When Si content exceeds 12 mass %, the alloy hardens, which makes working of the brazing material difficult.

When Ni content is less than 0.01 mass %, an effect of inhibiting dissolution of plating is not exhibited. When Ni content exceeds 30 mass %, the proportion of Ni occupying the brazing material is excessively high, and thus endurance of the brazed joint body to thermal stress may decrease.

The Al layer 11 is a layer of pure Al such as A1050. Alternatively, the Al layer may include impurities of up to about 5 mass % or so. The thickness of the Al layer 11 is preferably 0.005 to 0.1 mm.

The brazing material 3 is formed by bonding the Al layer 11 via the flux layer 15 on one side of the Al—Si—Ni based alloy layer 10. The flux layer 15 is, for example, a Nocolok-based flux. Manually pressing the Al layer 11 onto the flux layer 15 is sufficient as the bonding method.

The aforementioned brazed joint body 100 in the example of FIG. 2 is produced by the following method.

A1050 was used as the aluminum-based material 1 and SUS304 was used as the iron-based material 5. On the surface of the iron-based material 5, the Ni plating layer 4 of 3 μm thickness was formed. A foil of an alloy rolled to a thickness of 0.1 mm was used as the Al—Si—Ni based alloy layer 10. The alloy included 9.7 mass % of Si and 8.0 mass % of Ni, the balance being Al. The balance includes inevitable impurities.

An Al foil of 99% or more purity was used as the Al layer 11. Via the flux layer 15 as a paste of a mixture of Nocolok-based flux and ethanol, the Al layer 11 was bonded onto the Al—Si—Ni based alloy layer 10 to form the brazing material 3.

Nocolok-based flux was used for the flux layers 2a and 2b.

The materials described above were placed in a furnace as the structure of FIG. 3. The temperature in the furnace under nitrogen atmosphere was raised up to 600° C., heating was stopped at the time when the temperature reached 600° C., and the temperature of the furnace cooled down to room temperature.

For the brazed joint body 100, the reason that the strength of brazing between the aluminum-based material and the iron-based material improves compared with brazing according to the technique described in Patent literature 1 is described next.

Brazing of the aluminum-based material and the iron-based material suffers from a poor joint strength due to a brittle alloy generated at the interface between the Al—Si brazing material and the iron-based material. By conventional techniques, applying Ni plating to the iron-based material as a barrier layer is found to suppress growth of the brittle alloy and improve the strength. However, in the furnace brazing of the aluminum-based material and the iron-based material, the iron-based material is hard to increase in temperature and thus lengthens the heating time. As a result, the Ni plating dissolves in the Al—Si brazing material, which may result in failure to sufficiently exhibit an effect as the barrier layer. Various studies reveal that when the time when the temperature of the brazing material is equal to or greater than the melting point in the furnace brazing is 20 minutes, the Ni plating dissolves even when the thickness of the Ni plating of the barrier layer is 10 μm.

To suppress dissolution of the Ni plating, reduction in a dissolution rate of Ni into the Al—Si brazing material is effective. A rate at which solid elements dissolve in liquid is proportional to a difference in concentration between the saturation concentration of the solid in the liquid and the concentration at that time. In the present embodiment, Ni is added beforehand in the Al—Si brazing material, and Ni is allowed to exist in the liquid of molten Al—Si brazing material. This slows the rate of dissolution of the Ni plating into liquid. As a result, the dissolution of the Ni plating into the brazing material can be suppressed. At 600° C., up to 7.3 mass % Ni is found to dissolve in a molten Al—Si. Therefore, if the Ni concentration in the Al—Si brazing material is adjusted beforehand to 7.3 mass % or more, the dissolution rate approaches 0, thereby avoiding dissolution of the Ni plating. In this way, if elimination of the Ni plating due to dissolution can be prevented, formation of the brittle Al—Fe—Si based alloy layer can be suppressed, thereby improving the brazing strength.

The timing at which the Ni plating dissolves is preferably as follows. In FIG. 4, Ni exists as the Al—Ni alloy phase 12 in the Al—Si—Ni based alloy layer 10. A layer that reaches its melting point to first start melting in the brazing material 3 is the Al—Si—Ni based alloy layer 10. Thus the melting start temperature of the brazing material 3 corresponds to a melting point of the Al—Si—Ni based alloy layer 10. As the Al—Si—Ni based alloy layer 10 starts melting, the Al—Ni alloy phase 12 dissolves in the Al—Si base material 14. To suppress dissolution of the Ni plating layer 4 in this process of dissolution, in the period until the Ni plating layer 4 starts melting after the Al—Si—Ni based alloy layer 10 reaches the melting point, dissolving of the Al—Ni alloy phase 12 uniformly in the Al—Si—Ni based alloy layer 10 is important.

For uniform dissolution of the Al—Ni alloy phase 12, the Al layer 11 with a higher melting point than the Al—Si—Ni based alloy layer 10 is interposed between the Ni plating layer 4 and the Al—Si—Ni based alloy layer 10 to form the brazing material 3.

Brazing using the brazing material 3 with the above arrangement forms the Al—Ni based alloy layer 16 near the surface of the Ni plating layer 4. The Al—Ni based alloy layer 16 is advantageous in terms of tensile shear strength compared with the brittle Al—Fe—Si based alloy layer, but as for its thickness, layer thickness is preferably low.

The thickness of the alloy layer formed on the Ni plating layer 4 is relevant to the melting time of the brazing material and the tensile shear strength. The longer the melting time of the brazing material, the thicker the alloy layer becomes due to growth of the alloy layer, although the thickness depends on composition of the alloy layer. The tensile shear strength, although depending on the composition of the alloy layer, decreases with increased thickness of the alloy layer. When the tensile shear strength necessary as the brazed joint body is 40 MPa, the thickness of the alloy layer formed on the Ni plating layer 4 is preferably set to 20 μm or less.

Next, improvements of performance and joint strength of the brazing material 3 in the furnace brazing are further described.

First, after start of brazing, the temperature is raised and then the Al—Si—Ni based alloy layer 10 starts melting. Then the Al—Ni alloy layer 12 dissolves throughout the Al—Si base material 14. At this time, since the melting point of the Al layer 11 is higher than the melting point of the Al—Si—Ni based alloy layer 10, the Al layer 11 does not start to melt soon.

Then the Al layer 11 contacts Si in the Al—Si—Ni based alloy layer 10, and the melting point decreases. Then the Al layer 11 gradually melts and is integrated with the Al—Si—Ni based alloy layer 10. When the entire Al layer 11 melts and is integrated with the Al—Si—Ni based alloy layer 10, all the Al—Ni alloy phase 12 melts into the Al—Si—Ni based alloy layer 10. Dissolution of all the Al—Ni alloy phase 12 increases uniformity of Ni throughout the Al—Si—Ni based alloy layer 10. Uniform inclusion of Ni in the Al—Si—Ni based alloy layer 10 is a factor of suppressing dissolution of the Ni plating layer 4.

In addition, the dissolution rate of the Ni plating layer 4 slows down, and the concentration distribution of Ni in the Al—Si—Ni based alloy layer 10 is uniform. This generates a nearly spherical Al—Ni based alloy layer 16a in the Al—Si based alloy layer 18 after brazing. This nearly spherical Al—Ni based alloy layer 16a has an effect of suppressing occurrence of breakage in the brazing portion 6, which results in improved joint strength of the aluminum-based material 1 and the iron-based material 5.

As described above, according to the present embodiment, formation of a brittle Al—Fe—Si based alloy layer is suppressed during furnace brazing, and the Al—Ni based alloy layer is formed instead. The present embodiment thereby improves the joint strength of the brazed coupling.

Structures having a nearly spherical shape and distributed in a floating island-like pattern were observed to be formed in the Al—Si based alloy layer. Analysis showed that this structure is a phase containing Al and Ni at an approximately 3:1 atomic ratio. The presence of this nearly spherical Al—Ni alloy phase can help lessen propagation of cracks in the Al—Si base material, thereby improving brazing strength.

In addition, the interface between the Al—Ni based alloy layer and the Al—Si based alloy layer has an undulating shape that can help lessen breakage of the brazing portion. High durability with respect to tensile load and shear load can be thereby obtained.

### Embodiment 2

Embodiment 2 differs from Embodiment 1 in that the proportion of Ni included in the Al—Si—Ni based alloy layer 10 of the brazing material 3 is 7 to 15 mass %.

The Ni proportion of 7 to 15 mass % is preferable for improvement of inhibition of plating dissolution and improvement of workability to the brazing material.

The composition of Embodiment 2 enables sufficient exhibition of an effect of suppressing elimination of the Ni plating layer 4 during brazing and simplifying production of the Al—Si—Ni based alloy layer 10 by rolling.

### Embodiment 3

Embodiment 3 differs from Embodiment 1 in that the Al—Si—Ni based alloy layer 10 of the brazing material 3 includes at least one of Cr, Mn, Co, and Cu having a total concentration of 0.01 to 30 mass % relative to the Al—Si—Ni based alloy layer 10.

Addition of the at least one of Cr, Mn, Co, and Cu having a total concentration less than 0.01 mass % does not affect the strength of the brazed joint body. When the total concentration exceeds 30 mass %, affinity the produced alloy and the brazing material is lowered, which can trigger breakage. Thus the total concentration of the at least one of Cr, Mn, Co, and Cu is set to 0.01 to 30 mass %. More preferably, the upper limit of the total concentration is 20 mass % or less. This is because increasing the amounts of these additive elements hardens the alloy prior to processing into the brazing material and increases difficulties in working the brazing material.

According to the composition of Embodiment 3, the Al—Ni based alloy layer 16 and the nearly spherical Al—Ni based alloy layer 16a include at least one additive element of Cr, Mn, Co, and Cu. This can further enhance the effect of reducing suppressing elimination of the Ni plating layer 4.

### Embodiment 4

Embodiment 4 differs from Embodiment 1 in that the Al—Si—Ni based alloy layer 10 is not a rolled solid but a paste.

The paste Al—Si—Ni based alloy layer 10 includes a brazing material component, a binding solvent, and a Nocolok-based flux. The Al—Si—Ni based alloy layer 10 is produced by uniformly distributing, in the binding solvent, components of the Al—Si—Ni based alloy and the Nocolok-based flux.

The brazing material is a powder that includes 5 to 12 mass % of Si and 0.01 to 30 mass % of Ni, the balance being Al. The brazing material is formed from powder of each element or powder of an alloy of elements.

The binding solvent serves for fixing, on materials to be brazed, the brazing material components and the Nocolok-based flux in paste form. The binding solvent may be a known solvent, but preferably a solvent that is volatile at a temperature lower than a flux activation temperature, for example, 500° C. or less.

Proportions of the composition of the brazing material components, the binding solvent, and the Nocolok-based flux may be freely selected, but the proportion of the brazing material components is preferably of the order of 30%.

An effect on enhancement of the strength of a brazed portion between the aluminum-based material 1 and the iron-based material 5 by use of the paste Al—Si—Ni based alloy layer 10 is similar to that of Embodiment 1. In addition to this, use of the paste Al—Si—Ni based alloy layer 10 can achieve easy fixing of the brazing material between the complex-shaped aluminum-based material 1 and the iron-based material 5, thereby providing an increased degree of freedom in the shapes of materials to be brazed. The Al—Si—Ni based alloy layer 10 can be produced by mixing the Ni powder into Al—Si brazing material, and production of the Al—Si—Ni based alloy layer 10 can be simpler than production of a foil of Al—Si—Ni alloy.

### Embodiment 5

In the aforementioned embodiments, producing the brazed joint body 100 of FIG. 1 by furnace brazing the stack of FIG. 3 is described. In contrast, Embodiment 5 differs from the aforementioned embodiments in that a structure of coupled pipes is brazed using a wire-member brazing material 3 as illustrated in FIG. 5.

As illustrated in FIG. 5, the wire-member brazing material 3 has a core material that is an Al—Si—Ni alloy that is, in FIG. 5, made in an elongated cylindrical form. This core is also expressed here as the Al—Si—Ni based alloy layer 10 similar to that illustrated in FIG. 4, from the sense that the core is a radially innermost layer. The Al—Si—Ni based alloy layer 10 has the Al—Ni alloy phase 12 and the Al—Si alloy phase 13 that are distributed in the Al—Si base material 14, similarly to those described in Embodiment 1. The outside of the Al—Si—Ni based alloy layer 10 is covered with the Al layer 11. The flux layer 15 of the brazing material 3 of FIG. 4 is not used in forming the wire member of FIG. 5.

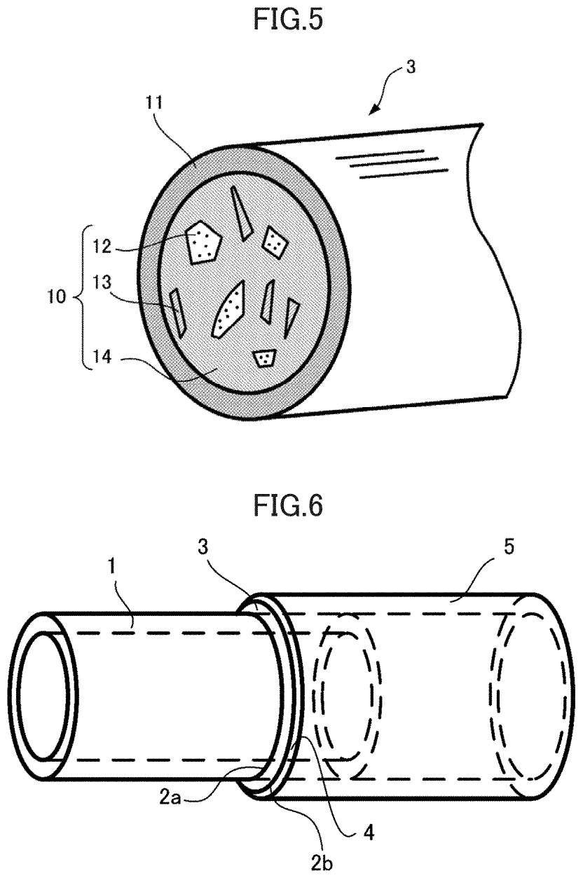

FIG. 6 is a drawing illustrating placement of materials when the aluminum-based material 1 and the iron-based material 5 are brazed in Embodiment 5. The state illustrated in FIG. 6 is used when joining pipes.

As illustrated in FIG. 6, the aluminum-based material 1 that is an aluminum pipe is inserted into the iron-based material 5 that is a steel pipe. The Ni plating layer 4 is formed in at least an area of the iron-based material 5 to be brazed. In this state, the brazing material 3 that is a wire member of FIG. 5 is wound around in a stepped portion between both the pipes. The flux layer 2a is applied between the aluminum-based material 1 and the brazing material 3, and the flux layer 2b is applied between the brazing material 3 and the iron-based material 5.

The brazed joint body can be obtained by furnace brazing, as in Embodiment 1, of the brazing structure placed as in FIG. 6.

The configuration of Embodiment 5 is preferable because use of the wire-member brazing material 3 enables easy to achievement of overlapping brazing when the aluminum-based material 1 and the iron-based material 5 are both formed as pipes.

### Embodiment 6

Embodiment 6 differs from Embodiment 1 in that Al particles are mixed in the flux layer 2b, instead of using the foil Al layer 11 and the flux layer 15 of the brazing material 3.

Specifically, the brazing material of Embodiment 6 and the brazing material 3 of FIG. 4 only have the Al—Si—Ni based alloy layer 10 in common. In addition, Al particles are mixed in the flux layer 2b between the brazing material and the Ni plating layer 4.

According to the composition of Embodiment 6, the Al particles are mixed beforehand in the flux layer 2b, which enables Al components corresponding to the Al layer 11 of Embodiment 1 to be placed at the same time of placement of the flux layer 2b. Thus Embodiment 6 is preferable for enabling simplification of placement of materials before brazing.

### Embodiment 7

Embodiment 7 differs from Embodiment 1 in that a brazing material 3a is used instead of the brazing material 3.

As illustrated in FIG. 8, a brazing material 3a is a stack that is the brazing material 3 of FIG. 4 with a Ni layer 20 added thereto. The Ni layer 20 has a thickness of 0.5 μm to 10 μm and is disposed between the Al—Si—Ni based alloy layer 10 and the flux layer 15.

Examples of ways of forming the Ni layer 20 include covering one side of the Al—Si—Ni based alloy layer 10 by Ni electrolytic plating or electroless plating. However, the way of forming the Ni layer 20 is not particularly limited.

After the Ni layer 20 is formed, the Al layer 11 is bonded on the surface of the Ni layer 20 via the flux layer 15, similarly to the brazing material 3. The brazing material 3a is thereby formed.

By use of the brazing material 3a, the amount of the nearly spherical Al—Ni based alloy layer 16a formed near the Ni plating layer 4 increases in the structure of the joint portion illustrated in FIG. 2. Thus the use of the brazing material 3a improves the joint strength of the brazed joint body 100.

### Embodiment 8

Embodiment 8 differs from Embodiment 1 in that a brazing material 3b is used instead of the brazing material 3.

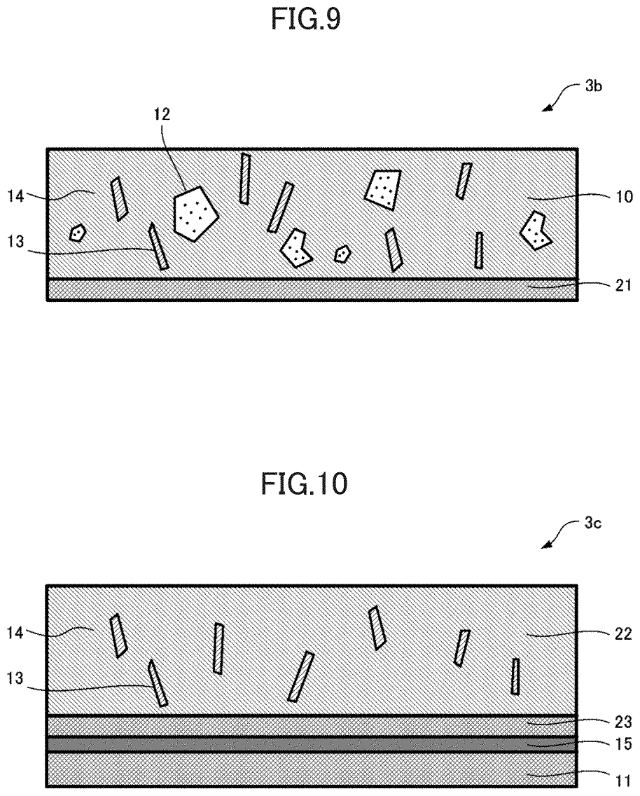

As illustrated in FIG. 9, the brazing material 3b is a stack of the Al—Si—Ni based alloy layer 10 and a Ni layer 21 provided on one side thereof. The Ni layer 21 has a thickness of 0.5 μm to 10 μm. The Ni layer 21 is formed in a way similar to that of the Ni layer 20 of Embodiment 7.

By use of the brazing material 3b, in comparison with the brazing material 3, the step of providing the Al layer 11 is omitted. Thus the use of the brazing material 3b enables the brazed joint body 100 to be produced more simply.

### Embodiment 9

Embodiment 9 differs from Embodiment 1 in that a brazing material 3c is used instead of the brazing material 3.

As illustrated in FIG. 10, the brazing material 3c is a stack of the Al layer 11, the flux layer 15, a Ni layer 23, and an Al—Si based alloy layer 22 sequentially from the lower side of FIG. 3, corresponding to the stacking direction in FIG. 3. The Al—Si based alloy layer 22 is located on the aluminum-based material 1 side, and the Al layer 11 is located on the iron-based material 5 side.

The Al—Si based alloy layer 22 is an Al—Si based alloy that is used as the brazing material. As illustrated in FIG. 10, when the cross section of the layer of the Al—Si based alloy layer 22 is viewed, the Al—Si alloy phase 13 is distributed in a floating island-like pattern in the Al—Si base material 14.

The Al—Si based alloy layer 22 can be produced by fabricating an alloy including 5 to 12 mass % of Si and then rolling the alloy into a plate-like form having a thickness of 0.05 to 0.2 mm.

The Ni layer 23 has a thickness of t (μm). Here, t (μm) is a thickness that is 5% or more thicker than that of the Al—Si based alloy layer 22.

Examples of ways of forming the Ni layer 23 includes covering one side of the Al—Si based alloy layer 22 by Ni electrolytic plating or electroless plating. However, the way of forming the Ni layer 23 is not particularly limited.

After the Ni layer 23 is formed, the Al layer 11 is bonded on the surface of the Ni layer 23 via the flux layer 15, similarly to the brazing material 3. The brazing material 3c is thereby formed.

When the Al—Si based alloy layer 22 melts in a heating process of brazing using the brazing material 3c, the Ni plating layer 4 illustrated in FIGS. 1 to 3 dissolves in the Al—Si based alloy layer 22. This can prevent dissolution of the Ni plating layer 4. As a result, a firm joint body can be obtained.

Thus, according to the present embodiment, without using the Al—Si—Ni based alloy layer 10, the brazing material 3c can be formed using the Al—Si based alloy layer 22. In other words, the firm brazed joint body 100 can be produced using, as the Al—Si based alloy layer 22, a commonly available Al—Si based alloy, for example, A4045.

### EXAMPLE

Examples of the present disclosure are hereinafter described in comparison with Comparative Examples. These Examples illustrate some aspects of the present disclosure, without particular limitation.

### Example 1

The brazed joint body 100 illustrated in FIG. 1 was used as a brazed joint body used in Example 1. The placement of materials of the structure for brazing and the brazing material 3 was as illustrated in FIGS. 3 and 4.

A1050 having a length of 54 mm, a width of 10 mm, and a thickness of 3 mm was used as the aluminum-based material 1, and SUS304 having similar dimensions as the aluminum-based material 1 was used as the iron-based material 5. The Ni plating having a thickness of 3 μm was covered on the surface of the iron-based material 5 by electrolytic plating to form a Ni plating layer 4.

The Al—Si—Ni based alloy layer 10 used was a plate-like member having a length of 4 mm, a width of 10 mm, and a thickness of 0.1 mm and included 9.7 mass % of Si and 8.0 mass % of Ni, the balance being Al. A thin foil Al layer 11 was bonded via a Nocolok (registered trade mark) flux layer 15 on the Al—Si—Ni based alloy layer 10 to form the brazing material 3 as illustrated in FIG. 4.

A paste obtained by mixing about a 4:1 proportion of ethanol and Nocolok-based flux powder was applied between the Ni plating layer 4 and the brazing material 3 and between the brazing material 3 and the aluminum-based material 1 to form the flux layers 2a and 2b.

After preparation of the above materials, as illustrated in FIG. 1, the brazed joint body 100 was obtained by heating up to 610° C. in a furnace under a nitrogen atmosphere and performing brazing, with the brazing material 3 sandwiched between the aluminum-based material 1 and the iron-based material 5 as illustrated in FIG. 3. Assuming that melting time of the brazing material 3 is defined as time when the temperature of the brazing material 3 at the heating exceeds a solidus temperature of the brazing material 3, the melting time of the brazing material 3 in Example 1 was approximately 20 minutes.

The brazed joint body of Comparative Example 1 was obtained by brazing in the same way as that of Example 1 except that a conventional material, A4045, was used instead of the brazing material 3 of Example 1.

A tensile test of applying at room temperature tensile shear force to brazing portions of brazing structures obtained by the above described Example 1 and Comparative Example 1 was conducted. The test results showed that both of the brazing structures suffered from breakage at the brazing portions. Stress obtained by dividing the breaking load at the movement of this breakage by a brazing area was taken to be the shear strength of the brazing portion. The cross sections of the brazing portions of the brazing structures obtained by the above described Example 1 and Comparative Example 1 were observed. For alloy layers formed into layers between an iron plate and an Al—Si brazing material, thicknesses of the compound were measured from the cross-sectional SEM image. For the alloy layer observed in an observation area having a brazing length L illustrated in FIG. 1 in a direction along the surface of the iron plane, the thicknesses of the alloy were measured at points obtained by division of the brazing length L into ten segments. Then the average was calculated, and the average thickness of the alloy layer was determined. The results are shown in Table 1.

TABLE 1

| | | Melting | | Average | | |
|---|---|---|---|---|---|---|
| | | time of | Shear | thickness | Composition | Nearly |
| | Brazing | brazing | strength | of alloy | of alloy | spherical |
| No. | material | material (min) | (MPa) | layer (μm) | layer | structure |
| Example 1 | Al-9.7 mass % | 20 | 49 | 13.7 | Al—Ni | Presence |
| | Si -8.0 mass % | | | | based | |
| | Ni, Al foil | | | | | |
| Comparative | A4045 foil | 20 | 33 | 27 | Al—Fe—Si | Absence |
| Example 1 | | | | | based | |

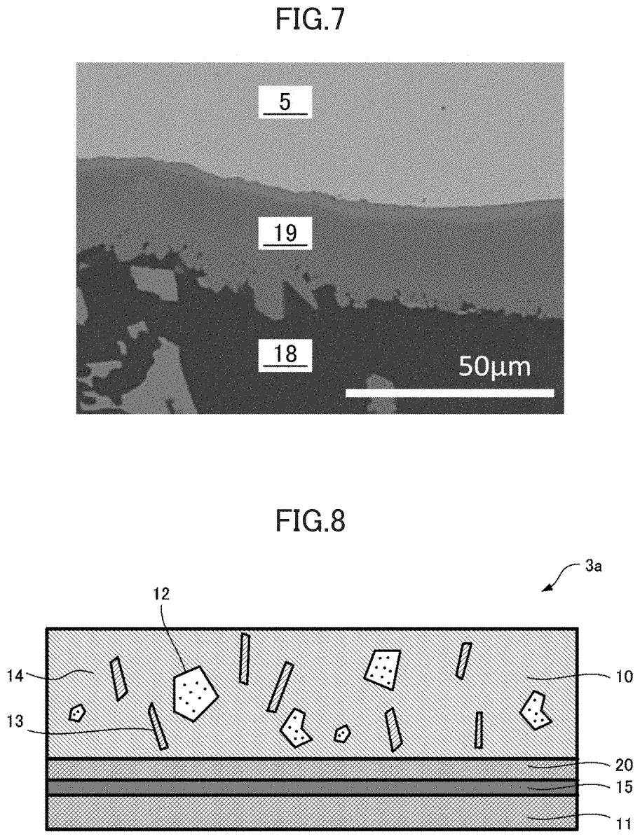

FIG. 7 illustrates the cross-sectional SEM image of the brazing portion of the brazing structure of Comparative Example 1. In Comparative Example 1, elimination of the Ni plating layer 4 occurred, and a brittle Al—Fe—Si layer 19 was formed. In Comparative Example 1, nearly spherical structures did not exist in the Al—Si base material.

In contrast, in Example 1 in which the Al—Si—Ni based alloy layer 10 and the Al layer 11 are used as main parts of the brazing material, the alloy layer formed on the Ni plating layer 4 was the Al—Ni based alloy. In Example 1, the thickness of the alloy layer decreased compared with Comparative Example 1.

In addition, nearly spherical structures were formed in Example 1.

The above results showed that Example 1 had improved shear strength of the brazing portion 6 compared with Comparative Example 1. That is, the brazed joint body having high strength was found to be obtainable the brazing material and the brazing method according to the present embodiment.

### Example 2

Example 2 is an example in which the brazed joint body was produced using a tubular member as in the brazing material 3 of FIG. 5 and the material placement drawing of FIG. 6.

A1050 was used as the tubular aluminum-based material 1 and SUS304 was used as the tubular iron-based material 5. The surface of the iron-based material 5 was covered by Ni plating having a thickness of 3 μm to form the Ni plating layer 4. A core material corresponding to the Al—Si—Ni based alloy layer 10 of the brazing material 3 was an Al—Si—Ni based alloy layer 10 including 9.7 mass % of Si and 8.0 mass % of Ni, the balance being Al. The Al layer 11 was covered around the core material, and the wire type brazing material 3 having a diameter of 2 mm was formed.

The flux layers 2a and 2b that are a Nocolok-based flux were applied between the aluminum-based material 1 and the brazing material 3 and between the brazing material 3 and the Ni plating layer 4. After application of the flux layers 2a and 2b, the brazing material 3 was placed in a stepped portion between the aluminum-based material 1 and the iron-based material 5. In this state, heating to 610° C. was performed in a furnace under nitrogen atmosphere, and brazing was performed.

Example 2 in which the brazed joint body was produced as described above also provided a brazed joint pipe having high strength compared with the conventional brazed joint pipe.

The present disclosure is not limited to the above described embodiments, and various modifications and applications can be made.

The aforementioned embodiments and examples showed examples of application to plate material and pipe. However, the present disclosure is not limited thereto, and can be applied to brazing of various shapes of materials.

The above described embodiments and examples showed examples of joints between the aluminum-based material and the iron-based material. However, the present disclosure is not limited thereto, and can be applied to other dissimilar metal joint parts.

As the aluminum-based material, A1050, which is a pure Al, is used, but the aluminum-based material is not limited thereto. Since a similar issue of growth of the brittle alloy occurs even for aluminum alloys other than pure Al, the embodiments described above can be used with advantage. For example, materials adapted to brazing like 3000 series aluminum alloy can be extensively used.

As the iron-based material, SUS304 is used, but the iron-based material is not limited thereto. Other steel materials can be extensively used.

FIG. 1 illustrates the Ni plating layer 4 at a portion of the brazing portion 6, but the Ni plating layer 4 may be formed on the surface of the iron-based material 5 other than the brazing portion 6. For example, the Ni plating layer 4 may be formed on the entire surface of the iron-based material 5.

In Embodiment 1, the brazing material 3 was formed by bonding the Al layer 11 via the flux layer 15 onto one side of the Al—Si—Ni based alloy layer 10. Alternatively, the bonding may be performed by a method of capable of forming the Al layer 11 without a gap, such as rolling, plating, evaporation, spraying, and painting.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2017-221838, filed on Nov. 17, 2017, the entire disclosure of which is incorporated by reference herein.

### INDUSTRIAL APPLICABILITY

The present disclosure can used with advantage for brazing between an aluminum-based material and an iron-based material.

### REFERENCE SIGNS LIST

1 Aluminum-based material
2a Flux layer
2b Flux layer
3, 3a, 3b, 3c Brazing material
4 Ni plating layer
5 Iron-based material
6 Brazing portion
10 Al—Si—Ni based alloy layer
11 Al layer
12 Al—Ni alloy phase
13 Al—Si alloy phase
14 Al—Si base material
15 Flux layer
16 Al—Ni based alloy layer
16a Nearly spherical Al—Ni based alloy layer
18 Al—Si based alloy layer
19 Al—Fe—Si based alloy layer
20, 21, 23 Ni layer
22 Al—Si based alloy layer
100 Brazed joint body

1. A brazed joint body of an aluminum-based material and an iron-based material plated with Ni, the brazed joint body comprising:
a layered structure including, sequentially from an iron-based material side, the iron-based material, a Ni plating layer, an Al—Ni based alloy layer, an Al—Si based alloy layer, and the aluminum-based material, wherein
a nearly spherical Al—Ni based alloy is formed in the Al—Si based alloy layer.

2. The brazed joint body according to claim 1, wherein an interface between the Al—Ni based alloy layer and the Al—Si based alloy layer has a smoothly continuous undulating shape.

3. The brazed joint body according to claim 1, wherein an average thickness of the Al—Ni based alloy layer is 20 μm or less.

4. The brazed joint body according to claim 1, wherein the Al—Ni based alloy layer and the nearly spherical Al—Ni based alloy includes at least one of Cr, Mn, Co, and Cu.

5. A brazing method comprising:
preparing a brazing material that includes an Al—Si—Ni based alloy containing Al, Si, and Ni, and an Al layer;
forming a structure by interposing the brazing material between an iron-based material plated with Ni and an aluminum-based material such that the Al—Si—Ni based alloy is located on an aluminum-based material side and the Al layer is located on an iron-based material side;
heating the structure in a furnace under an inert atmosphere so that a temperature of the brazing material is equal to or higher than a melting start temperature of the brazing material; and
cooling the heated structure.

6. The brazing method according to claim 5, wherein the Al—Si—Ni based alloy has a composition of 5 to 12 mass % of Si and 0.01 to 30 mass % of Ni, the balance being Al and inevitable impurities.

7. The brazing method according to claim 5, wherein time when the temperature of the brazing material is equal to or higher than the melting start temperature of the brazing material is set so that an average thickness of an Al—Ni based alloy layer formed between the Ni plating and the brazing material is 20 μm or less.

8-10. (canceled)

11. A brazing material comprising:
an Al—Si—Ni based alloy containing Al, Si, and Ni;
an Al layer; and
a Ni layer disposed between the Al—Si—Ni based alloy and the Al layer.

12. A brazing method comprising:
preparing a brazing material that includes an Al—Si—Ni based alloy containing Al, Si, and Ni, and a Ni layer formed on the Al—Si—Ni based alloy;
forming a structure by interposing the brazing material between an iron-based material plated with Ni and an aluminum-based material such that the Al—Si—Ni based alloy is located on an aluminum-based material side and the Ni layer is located on an iron-based material side;
heating the structure in a furnace under an inert atmosphere so that a temperature of the brazing material is equal to or higher than a melting start temperature of the brazing material; and
cooling the heated structure.

13. (canceled)

14. A brazing method comprising:
preparing a brazing material that includes an Al—Si based alloy containing Al and Si, an Al layer, and a Ni layer disposed between the Al—Si based alloy and the Al layer;
forming a structure by interposing the brazing material between an iron-based material plated with Ni and an aluminum-based material such that the Al—Si based alloy is located on an aluminum-based material side and the Al layer is located on an iron-based material side;
heating the structure in a furnace under an inert atmosphere so that a temperature of the brazing material is equal to or higher than a melting start temperature of the brazing material; and
cooling the heated structure.

15. A brazing material comprising:
an Al—Si based alloy containing Al and Si;
an Al layer; and
a Ni layer disposed between the Al—Si based alloy and the Al layer.

16. The brazing material according to claim 15, wherein the Ni layer has a thickness of 5% or more of a thickness of the Al—Si based alloy.
